(19) United States
(12) Patent Application Publication
(10) Pub. No.: US 2007/0178821 A1
(43) Pub. Date: Aug. 2, 2007

(54) Vehicle airflow system

(76) Inventor: Michael Zimmerman, Ida, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/340,878

(22) Filed: Jan. 27, 2006

(51) Int. Cl. B60H 1/00

(52) U.S. Cl. 454/69

(57) ABSTRACT

An airflow system is described having a housing. The housing includes a first opening, a second opening, and an interior portion position therebetween. At least one first airflow member is disposed proximate the first opening and an air freshener compartment is disposed proximate the interior portion position.

### TECHNICAL FIELD

Described herein is an airflow system and method, and more particularly, an airflow system and method for improving the interior odor of a vehicle.

### BACKGROUND

In a passenger compartment of a vehicle, drivers place air fresheners on an internal component of the vehicle to enhance the smell of the internal compartment. In some cases, unpleasant odors such as tobacco smoke or some material being carried in the interior compartment may cause an unpleasant odor.

Various solutions have been proposed for scent enhancement and odor concealment or elimination. One expedient has been to hang an air freshener from a rear-view mirror or attach it to a vent. However, hanging air fresheners from the rear-view mirror obstructs the drivers view during driving conditions. Attaching the air freshener to a vent of the vehicle blocks the airflow through the vent. Furthermore, there is an inability to control the intensity of the scent or remove it when it is no longer desired.

The need arises for an air freshening and/or scenting device that is easily and quickly installable in and removable from the airflow system of the vehicle. The air freshener should be easily replaceable when the supply of scent therein is depleted, and should be unobtrusive when installed. Further, the air freshener should impinge as little as possible upon the airflow delivered by the vent. Moreover, the air freshener should be relatively simple to install and to manipulate as desired by the operator of the vehicle.

### SUMMARY

In the embodiments described herein, an airflow system is employed having a housing that includes a first opening, a second opening, and an interior portion position therebetween. At least one first airflow member is disposed proximate the first opening and an air freshener compartment is disposed proximate the interior portion position.

### BRIEF DESCRIPTION OF THE DRAWINGS

The features and inventive aspects of the present invention will become more apparent from the following detailed description, the appended claims, and the accompanying drawings, of which the following is a brief description:

FIG. 1 is a side elevational view of a vehicle, partially broken away to reveal an interior cabin space and showing one embodiment of an airflow system;

FIG. 2 is a perspective view of an instrument panel of the vehicle of FIG. 1, showing a plurality of examples of an airflow outlet;

FIG. 3 is a perspective view of one embodiment of an airflow outlet;

FIG. 4 is a cross-sectional view of a second embodiment of an airflow outlet taken along sectional line 4-4 in FIG. 3;

FIG. 5 is a partial cutaway perspective view of a third embodiment of an airflow outlet, showing louvers disposed adjacent to an air freshener;

FIG. 6 is a top plan view of the air freshener compartment of FIG. 5;

FIG. 7 is a partial cutaway perspective view of a fourth embodiment of an airflow outlet showing an aperture and a heating element;

FIG. 8 is a top plan view of the air freshener compartment of FIG. 7; and

FIG. 9 is a top plan view of an embodiment of an airflow system showing an air freshener opening disposed on a surface of an interior of a vehicle.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

The term “airflow” as used throughout the specification is defined hereinafter to include but is not limited to: a selective movement or circulation of air; a selective amount of air; a general movement of air; and an amount of air that flows in a given period of time. The term “housing” as used throughout the specification is defined hereinafter to include but is not limited to: a frame, bracket, and structure. The term “air freshener” as used throughout the specification is defined hereinafter to include but is not limited to: a chemical or biological compound or structure that provides a distinctive odor; something tangible that allows an individual to perceive or identify it by the sense of smell; a pleasant odor; and a perfume. The term “compartment” as used throughout the specification is defined hereinafter to include but is not limited to: one of the parts or spaces into which an area is subdivided; a separate section or chamber; a space or subdivision; and a partitioned section within a larger area. The term “inlet” as used throughout the specification is defined hereinafter to include but is not limited to: a passage leading into a cavity; an opening of a cavity; and an opening providing entrance or intake. The term “outlet” as used throughout the specification is defined hereinafter to include but is not limited to: a passage for escape or exit; a vent; and an opening or a place through which something is let out. The term “intensity” as used throughout the specification is defined hereinafter to include but is not limited to: selection of concentration, power, or force; and the magnitude of a quantity (as force or energy) per unit (as of surface, charge, mass, or time). The term “actuator” as used throughout the specification is defined hereinafter to include but is not limited to: a device responsible for actuating a mechanical or electrical device; a mechanism that puts something into action; a mechanism that turns something on or off; a handle; and a control switch or dial.

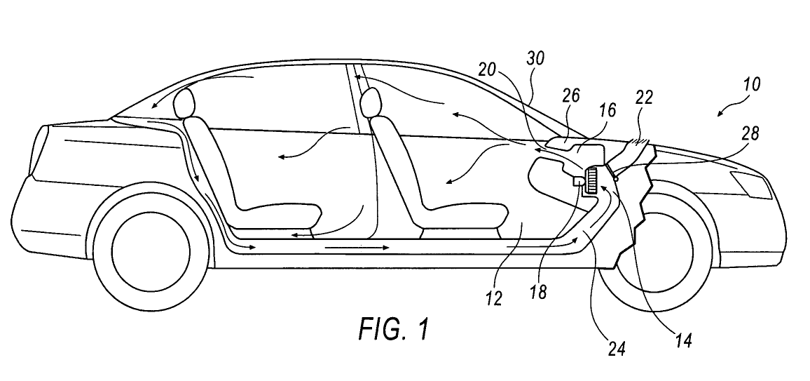

Referring to FIG. 1, a vehicle 10 is shown partially broken away to reveal an interior cabin 12 and an airflow system 14. The airflow system 14 includes a housing 16 at the front of the cabin 12 and a blower 18 that forces air out of the housing 16 and through an airflow outlet 20 into the cabin 12. The blower 18 pulls air in through two alternate sources, a “fresh” or exterior airflow inlet 22, which is disposed outside the cabin 12 and a recirculation airflow inlet 24 located below the exterior airflow inlet 22, generally below an instrument console or panel 26. The blower 18 is located generally between the airflow inlets 22, 24 and the airflow outlet 20. Located in front of the blower 18 is a control valve 28, which may be selectively moved between positions allowing air to be drawn by way of the exterior airflow inlet 22 and the recirculation airflow inlet 24.

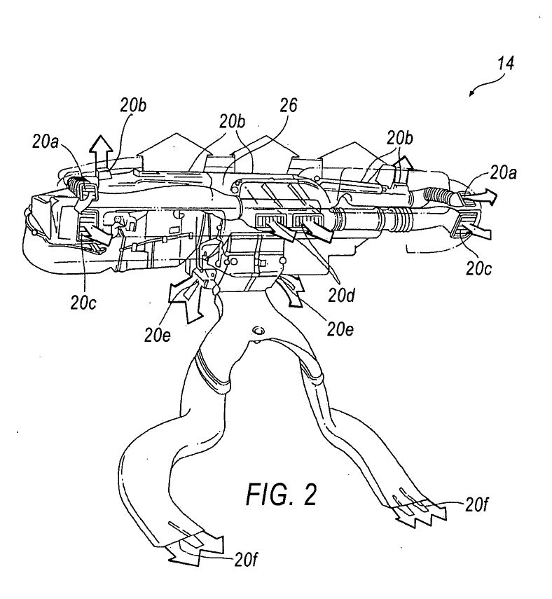

Referring to FIGS. 1 and 2, the instrument panel 26 of the airflow system 14 may include any number and any configuration of the airflow outlets 20 shown by way of example as 20a-20f. The instrument panel 26 is shown having defroster airflow outlets 20a and 20b for defrosting a windshield 30 of the vehicle 10. The instrument panel 26 further includes outer airflow outlets 20c and central airflow outlets 20d for directing airflow onto a driver and passenger. The lower airflow outlets 20e and 20f are used for directing airflow at the floor of the cabin 12. The interior portion of the airflow system 14 is defined between the airflow inlets 22, 24 and the airflow outlets 20.

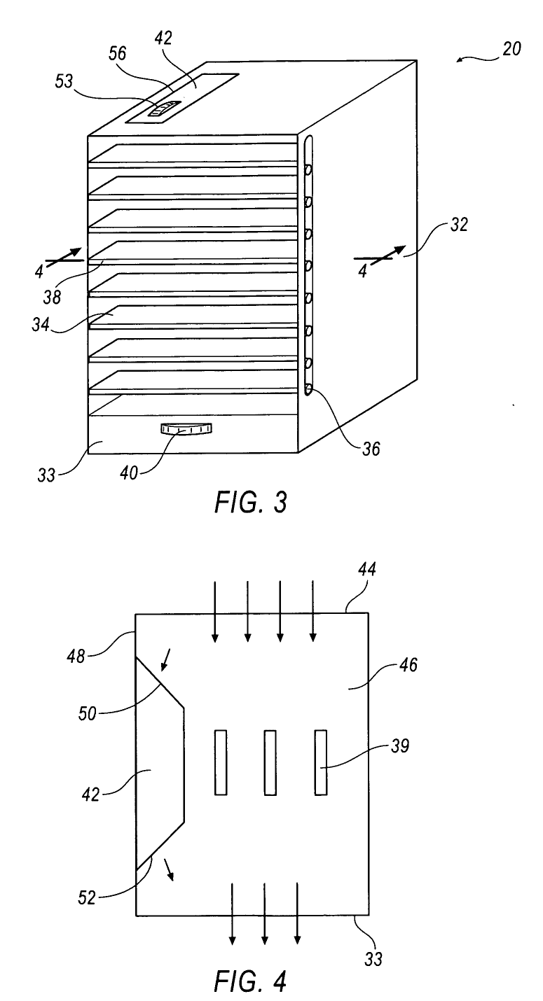

Referring now to FIG. 3, one embodiment of an airflow outlet 20 is shown having a body 32 adapted to be selectively disposed inside the instrument panel 26. The body 32 may include a plurality of louvers 34 disposed at a front portion 33 of the body 32 and adapted to selectively rotate about a respective hinge point 36. However, the location, type, size, configuration, and orientation of the louvers 34 may vary and the inclusion of the louvers 34 is optional. By way of example, the louvers 34 may be configured to be horizontal, vertical, and canted. The body 32 is shown as generally rectangular. However, the body 32 may be any shape and size as required to fit inside the instrument panel 26 or any other vehicle interior component. Furthermore, the body 32 may be configured to be fixed to the instrument panel 26 or may be detachable. As each louver 34 rotates about the hinge point 36, a user may move the airflow outlet 20 between an open and closed position. In the open position the louvers 34 are oriented to permit airflow into the cabin 12 and allow the user to direct airflow in a desired direction. In the closed position the louvers 34 are in an orientation that minimizes airflow into the cabin 12 in that the edges 38 of each louver 34 are in a generally upward or downward orientation. The louvers 34 may be manually rotated by pressing in an upward or downward direction on one of the louvers 34 or may be selectively rotated by a vent actuation member 40. Movement in either a right or left direction of the vent actuating member 40 may either open or close the louvers 34 as required by the user.

In another embodiment, the louvers 34 may be in a vertical or a horizontal orientation and may include a second row of louvers 39 as shown in FIG. 4 disposed behind the front portion 33 of the body 32. As shown in FIGS. 3 and 4, the airflow outlet 20 includes an air freshener compartment 42. The air freshener compartment 42 may be disposed anywhere in the interior portion of the airflow system 14. By way of example, a position or point between at least any one of the airflow inlets 22, 24 and at least any one of the airflow outlets 20 is contemplated. In one embodiment, the air freshener compartment 42 is disposed between the front portion 33 and a rear portion 44 of the interior portion 46 of the body 32. By way of example, the air freshener compartment 42 is shown fixed to an interior vent wall 48 of the body 32. However, the air freshener compartment 42 may be attached to any wall of the body 32 or may be disposed anywhere in the interior portion 46 of the body 32. Furthermore, the air freshener compartment 42 may be disposed anywhere between the airflow inlet 22, 24 and the airflow outlet 20 of the airflow system 14 as discussed below.

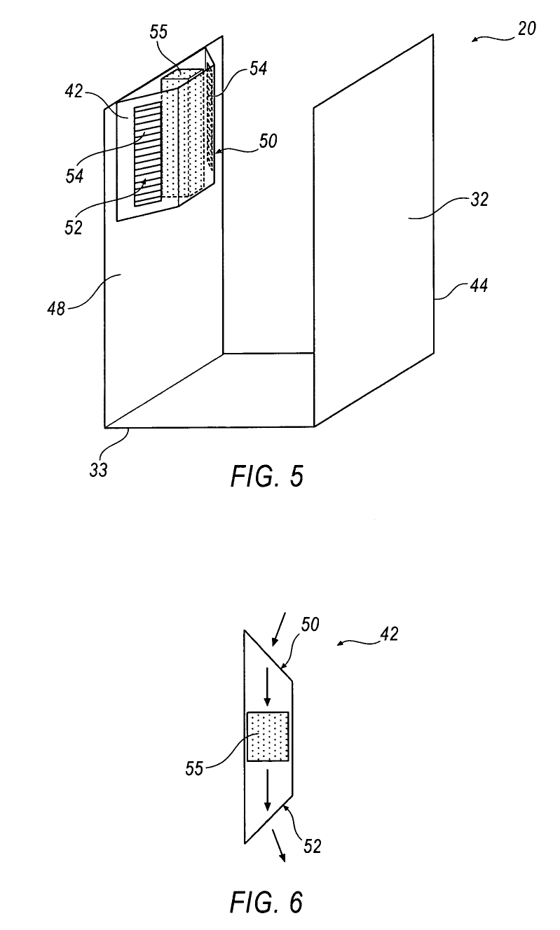

The air freshener compartment 42 includes an air freshener inlet 50 proximate the rear portion 44 of the body 32 and an air freshener outlet 52 proximate the front portion 33. The amount of airflow between the air freshener inlet 50 and the air freshener outlet 52 may be selectively controlled by an intensity actuator 53 disposed on the exterior surface of the body 32. In one embodiment shown in FIG. 3, the intensity actuator 53 is in the form of a mechanical or electrical wheel, lever, dial, switch, or slide. In each example, the intensity actuator 53 mechanically or electrically activates a mechanism for varying the intensity of odor in the cabin 12. In the embodiment shown in FIG. 5, the intensity may be adjusted by louvers 54 or the like placed at the inlet 50, the outlet 52, or both. The intensity of the scent increases the more the louvers 54 are open by selectively moving the intensity actuator 53 in a first direction, allowing greater airflow to move past the air freshener 55. The mechanism for moving the louvers 54 between an open and closed position includes any mechanical or electrical mechanism known to one of ordinary skill in the art. In another embodiment, the intensity actuator 53 activates and deactivates a mechanism for increasing the scent released into the cabin 12 including a fan and an electrical heating element.

FIG. 6 is a top view of the air freshener compartment 42 of FIG. 5, showing the controlled airflow moving through an air freshener 55. In one embodiment, the air freshener compartment 42 includes an upper portion 56 that has an opening (not shown) for inserting the air freshener 55 into the air freshener compartment 42. However, the air freshener 55 may be inserted into the air freshener compartment 42 in other ways, including: through the rear portion 44 of the body 32; through an opening in the vent wall 48; or through either the air freshener inlet 50 or outlet 52 and the bottom of the body 32. Furthermore, the body 32 may be removed from the instrument panel 26 for inserting the air freshener 55 into the air freshener compartment 42. A mechanism for securing the air freshener 55 includes the air freshener compartment 42 as described above and any structure adapted to hold the air freshener 55 in the interior portion of the airflow system 14 at a specific position. By way of example, the mechanism for securing the air freshener 55 may further include a card slot mechanism (not shown) and the like for inserting into a slot (not shown) and the like of the airflow system 14. A portion of the card slot mechanism secures to a surface of the airflow system 14. The air freshener 55 is thereby disposed at a specific position in the interior portion of the airflow system 14.

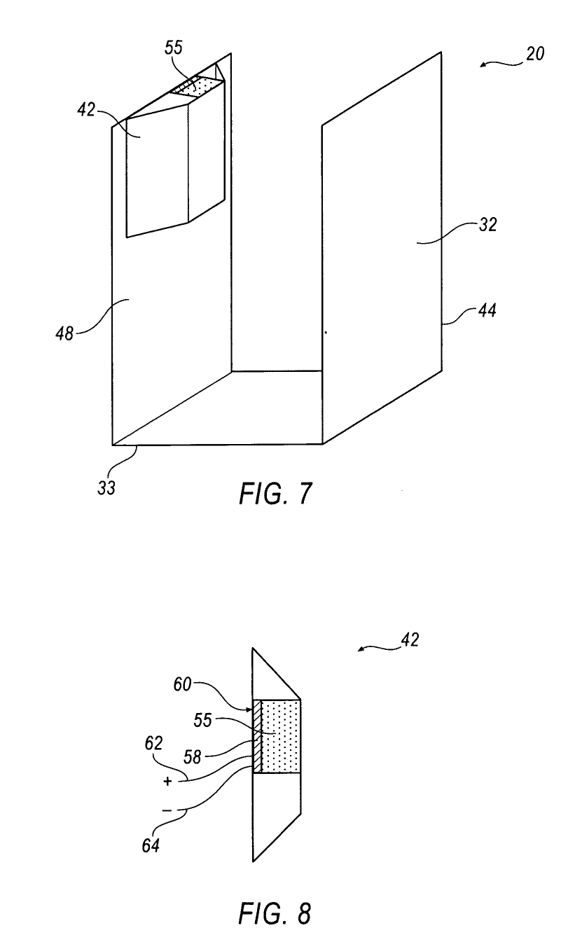

Now referring to FIG. 7, there is shown another embodiment of the air freshener compartment 42. The inlet 50 and the outlet 52 of FIGS. 5 & 6 are optional because air is not required to pass by the air freshener to expel the scent into the cabin 12. The air freshener compartment 42 may include a heating element 58 configured to facilitate the controlled release of the scent and provide the user further control of releasing various scents, including oil based scents, into the cabin 12. The heating element 58 may be disposed inside the air freshener compartment 42 or may be integrated with the vent wall 48 of the body 32. The heating element 58 includes a heating plate 60 powered by a positive terminal 62 and a negative terminal 64. A switch (not shown) may be disposed anywhere on the exterior of the body 32 or on the instrument panel 26 for activating and deactivating the heating element 58. By way of example, the air freshener 55 heated by the heating plate 60 disperses scent into the airflow outlet 20 by the convection of the heated air.

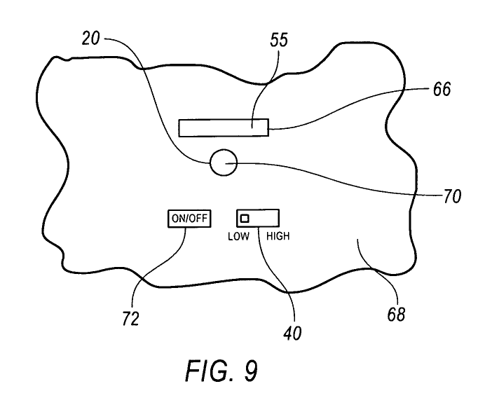

Referring now to FIG. 9, as stated above, the air freshener 55 may be disposed anywhere in interior airflow system 14 between the airflow inlet 22, 24 and the airflow outlet 20 of the vehicle 10. In one embodiment, the air freshener compartment 42 is disposed below the instrument panel 26 in the interior portion of the airflow system 14. An opening 66 may be disposed anywhere between the airflow inlet 22, 24 and the airflow outlet 20 on an interior surface 68 of the cabin 12. Further, in one embodiment, the airflow outlet 20 may be an aperture 70 disposed on the interior surface 68 proximate the opening 66. In another embodiment, a selector switch 72 may be disposed anywhere in the cabin 12 and configured to activate or deactivate the heating plate 60 as discussed above. Furthermore, a manual or electrical actuating member 40 may also be disposed anywhere in the cabin 12 and configured to selectively adjust the amount of airflow or scent released into the cabin 12 from the air freshener, as discussed above.

A method of providing a scent into the cabin 12 of the vehicle 10 includes: providing the airflow system 14 having the airflow inlet 22, 24, the airflow outlet 20, and an interior portion position defined therebetween; the airflow system 14 being at least partially disposed inside the vehicle instrument panel 26; and securing the air freshener 55 inside the interior portion; and the airflow system 14 including a selective airflow having a scent released in response to the airflow. The method may further include selectively moving the intensity actuator 53 to vary the intensity of the scent while allowing the airflow to enter the vehicle interior. The method may also include selectively heating the air freshener.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. An airflow system comprising:
a housing having a first opening, a second opening, and an interior portion position therebetween;
at least one first airflow member disposed proximate the first opening; and
an air freshener compartment disposed proximate the interior portion position.

2. The airflow system of claim 1, wherein the air freshener compartment includes an inlet opening and an outlet opening.

3. The airflow system of claim 2, wherein the air freshener compartment includes at least one air freshener compartment airflow member disposed proximate the outlet opening.

4. The airflow system of claim 3, wherein the housing includes an intensity actuator for selective movement of the at least one air freshener compartment airflow member between an open position and a closed position.

5. The airflow system of claim 1, wherein the housing includes at least one second airflow member disposed between the at least one first airflow member and the second opening and an intensity actuator disposed proximate the first opening, the intensity actuator selectively moving the at least one second airflow member between an open position and a closed position.

6. The airflow system of claim 1, wherein the housing is selectively removable by an occupant from a vehicle console.

7. The airflow system of claim 1, wherein the housing includes an air freshener opening for inserting an air freshener.

8. The airflow system of claim 7, wherein the air freshener opening is in operational communication with an opening in a vehicle console.

9. The airflow system of claim 1, wherein the housing includes a heating element for selective heating of an air freshener.

10. The airflow system of claim 9, wherein the housing includes a power terminal having a positive terminal and a negative terminal for providing power to the heating element.

11. A vehicle airflow system disposed in a vehicle console comprising:
an airflow structure having an airflow inlet portion, an airflow outlet portion, and an interior portion position therebetween, the airflow structure being at least partially disposed inside the vehicle console;
a first mechanism that selectively moves air from the air inlet portion to the airflow outlet portion; and
a second mechanism that secures an air freshener proximate the interior portion position.

12. The airflow system of claim 11, further including a third mechanism that selectively moves a component disposed proximate the interior portion position so that a selected intensity of air flows past the air freshener.

13. The airflow system of claim 11, further including a third mechanism that selectively moves of at least one louver between an open and a closed position.

14. The airflow system of claim 11, wherein the airflow structure includes at least one airflow member disposed proximate the airflow outlet portion.

15. The airflow system of claim 14, further comprising at least one second airflow member disposed between the at least one first airflow member and the airflow inlet portion and an intensity actuator disposed proximate the airflow outlet portion, the intensity actuator selectively moving the at least one second airflow member between an open position and a closed position.

16. The airflow system of claim 11, further comprising a ventilator housing disposed proximate the airflow outlet portion, the housing being selectively removable by an occupant from the vehicle console.

17. The airflow system of claim 11, wherein the housing includes a fifth mechanism that heats the air freshener.

18. A method of providing a scent into a vehicle interior comprising:
providing an airflow structure having an airflow inlet portion, an airflow outlet portion, and an interior portion position therebetween, the airflow structure being at least partially disposed inside the vehicle console;
securing an air freshener proximate the interior portion position; and
the airflow structure including a selective airflow providing a scent that releases an intensity of the scent in response to the airflow.

19. The method of claim 18, further including selectively moving an intensity actuator that varies an intensity of the scent while allowing the airflow to enter the vehicle interior.

20. The method of claim 18, further including selectively heating the air freshener.
